(19) United States
(12) Patent Application Publication
(10) Pub. No.: US 2003/0126461 A1
(43) Pub. Date: Jul. 3, 2003

(54) Audio/visual URL icon

(76) Inventors: John Barker, Houston, TX (US); Terry Koh, Singapore (SG)

Correspondence Address: CONLEY ROSE, P.C., P. O. BOX 3267, HOUSTON, TX, 77253-3267, US

(21) Appl. No.: 10/034,897

(22) Filed: Dec. 28, 2001

(51) Int. Cl. H04L 9/00; G06F 15/16

(52) U.S. Cl. 713/200; 709/229

(57) ABSTRACT

A process by which a user accesses a web site through the use of a mnemonic associated with the desired site, rather than through the use of the site's actual URL. The mnemonic may be text or an audio or video representation. An on-line service converts the mnemonic to a URL, which then can be used by the user to access the target web site.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates Internet Uniform Resource Locator (“URL”) icons. More particularly, the invention relates to using audio or video-based URL icons to access Internet web sites.

2. Background Information

It is commonly known that an Internet web page is accessed through the use of a Uniform Resource Locator (“URL”). A URL generally takes the form of “www.companyname.com” and are typed in to a web browser application by a user. Web pages are notoriously difficult to remember and say because the syntax must be communicated exactly right (e.g., URLs cannot be misspelled). Further, many URLs are relatively long and have various slashes, dots and other punctuation marks. Accordingly, there is a need to provide a better mechanism for accessing web pages than the current mechanism whereby a URL is entered in a web browser.

### BRIEF SUMMARY OF THE PREFERRED EMBODIMENTS OF THE INVENTION

The problems noted above are solved in large part by a process whereby a user can access a web site through the use of a mnemonic associated with the desired site, rather than through the use of the site's actual URL. The mnemonic may be text or an audio or video representation and is converted by an on-line service to the target web site's URL.

In accordance with one embodiment of the invention, a text, audio, or video-based mnemonic is registered with an on-line mnemonic conversion service which has access to a database. The database contains registered mnemonics and associated URLs. The user's system transmits the mnemonic to the mnemonic conversion service which, in turn, converts the mnemonic to a URL. The URL is then used in accordance with known techniques to access the desired website either by providing it back to the user's system or redirecting the user directly.

As noted above, the mnemonic may be text or audio or video-based. An audio mnemonic, for example, can be spoken by the user or embedded in an audio stream. The audio stream may be part of a video. Speech recognition software can be included to convert audio signals to recognizable speech to assist in this activity. A text mnemonic could be any alphanumeric character string representative of the target web site.

The preferred embodiments described above permit users to access web sites without the burden of having to know or obtain the site's URL. These and other advantages will become apparent upon reviewing the following disclosure.

### BRIEF DESCRIPTION OF THE DRAWINGS

For a detailed description of the preferred embodiments of the invention, reference will now be made to the accompanying drawings in which:

FIG. 1 shows an architecture in accordance with the preferred embodiment by which a client system can access a target web page through the use of a mnemonic of a URL and need not enter the URL itself in a web browser; and

FIG. 2 shows a method of accommodating URL mnemonics using the architecture of FIG. 1;

FIG. 3 illustrates an audio mnemonic embedded in an audio stream; and

FIG. 4 illustrates a video mnemonic on a client display.

### NOTATION AND NOMENCLATURE

Certain terms are used throughout the following description and claims to refer to particular system components. As one skilled in the art will appreciate, computer companies may refer to a component and sub-components by different names. This document does not intend to distinguish between components that differ in name but not function. In the following discussion and in the claims, the terms “including” and “comprising” are used in an open-ended fashion, and thus should be interpreted to mean “including, but not limited to . . . ”. Also, the term “couple” or “couples” is intended to mean either a direct or indirect electrical connection. Thus, if a first device couples to a second device, that connection may be through a direct electrical connection, or through an indirect electrical connection via other devices and connections. To the extent that any term is not specially defined in this specification, the intent is that the term is to be given its plain and ordinary meaning.

### DETAILED DESCRIPTION OF THE PREFERRED EMBODIMENTS

In accordance with the preferred embodiment of the invention, a user accesses web sites through the use of a mnemonic associated with the desired sites, rather than through the use of the sites' actual URLs. The mnemonic may be text or an audio or video representation and is converted by an on-line service to the target web site's URL. As explained below, the mnemonic is simply any text, audio or video representation of a URL.

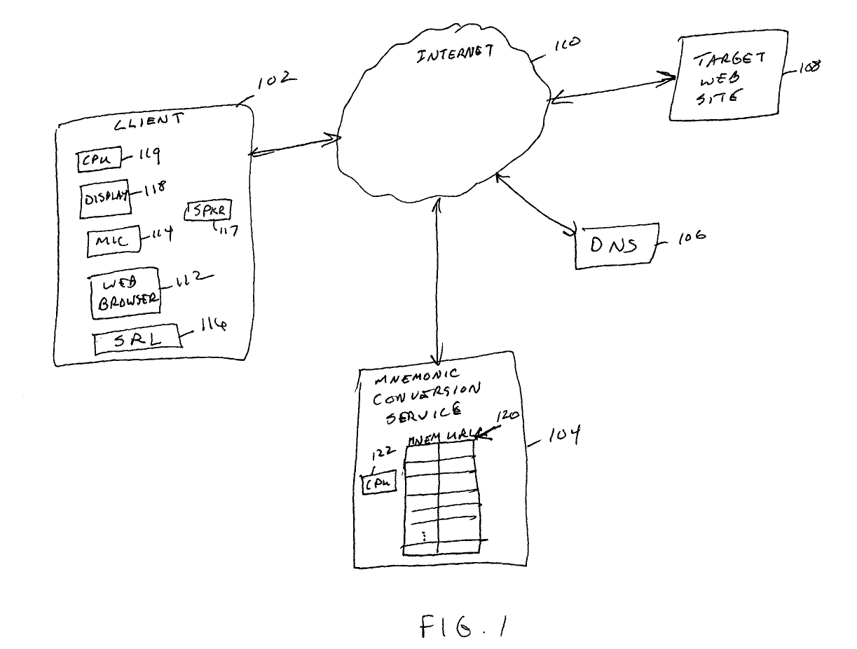

There are numerous embodiments of a system that accommodates URL mnemonics. One such embodiment is shown in FIG. 1. Referring to FIG. 1, a client 102, a mnemonic conversion service 104, and a target web page 108 are shown coupled together via a network 110 which, for example, can be the Internet. The client 102 is simply any entity, such as a computer or audio appliance, that has Internet access. The client may have a processor 119, a display 118, a speaker 117, and an input device, such as a microphone 114, a keyboard or a mouse, all coupled together if desired. The term “client” does not imply any relationship whatsoever to the mnemonic conversion service 104 or the target web page 108. Although only one client 102 is shown for clarity in explaining how a single client can use URL mnemonics, it should be known that the system works for any number of clients. Further, a single target web page 108 is shown to which the client 102 attempts to access. In general, the system works for any number of web pages. Most generally, the system simply permits a client to access a web site using a text/audio/video mnemonic and not have to use that web site's precise URL.

As noted, a mnemonic is used by the client to access a web page. Each web site that wishes to permit access to clients using a mnemonic, preferably registers its mnemonic with the mnemonic conversion service 104. The mnemonic can be virtually anything other than the URL itself. For example, the mnemonic could be an alphanumeric character string such as “Compaq.” Alternatively, the mnemonic could be an audio signal or even a video image. An audio mnemonic could be a DTMF-like series of tones, an audio phrase such as an audible version of the word “Compaq,” or any other type of audio representation. As a video image, the mnemonic could be, for example, a web site's logo. The video mnemonic could be a static image or a moving image.

At any rate, the mnemonic is registered with the mnemonic conversion service 104. The registration includes storing the mnemonic in a conversion table 120. An exemplary embodiment of the conversion table 120 shown in FIG. 1 includes a plurality of entries, each entry including storage for a mnemonic and the actual URL associated with that mnemonic. If the mnemonic comprises an alphanumeric character string, that character string is stored in the table. If the mnemonic, however, comprises an audio signal, a digital representation of that audio signal is stored in the table. Similarly, for a video image-based mnemonic, a digital representation of that mnemonic is stored in the table 120. Other information associated with the website registering its mnemonic may be provided during the registration process such as a description of the website, contact information, and the like.

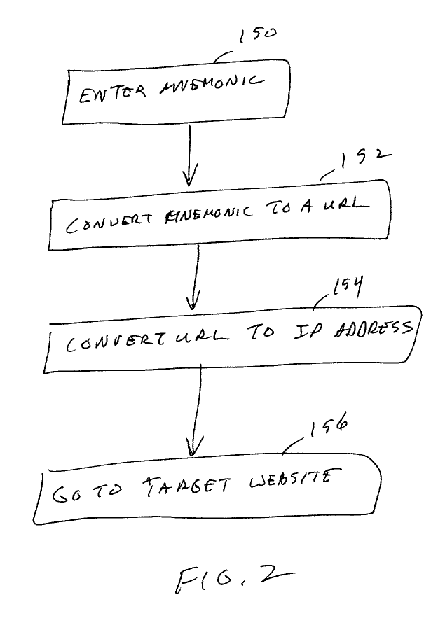

Once the mnemonic and URL are registered with the mnemonic conversion service 104, the client 102 can use the registered mnemonic to access the target web page 108. That process is shown in FIG. 2, which should be reviewed in connection with FIG. 1. As shown, in step 150, the user enters the mnemonic on the client system 102. The entry of the mnemonic can be in accordance with any one of a variety of techniques. For example, if the mnemonic comprises an alphanumeric character string (e.g, “Compaq”), the user could simply enter the mnemonic in the address field of the client's web browser 112. The web browser can be designed to distinguish between a URL and a mnemonic by some means such as prior knowledge of a set of reserved words or by reference to the DNS 102 which can inform the client if the character string is a valid URL or not. Once the web browser determines that the user has entered a mnemonic, the browser accesses the mnemonic conversion service 104 via its URL. The mnemonic conversion service's URL can be programmed into the client's web browser as an option tied to the mnemonic function. That is, an option can be provided in the web browser settings that permits a user to specify the URL for the mnemonic conversion service. Then, whenever the browser detects a mnemonic, the browser goes to the URL specified for the conversion service. Alternatively, the user could simply go to the web site associated with the mnemonic conversion service 104 and enter the mnemonic, through a graphical user interface provided by the conversion service.

Further, if the icon is an audio signal, a microphone 114 associated with the client 102 is used through which to speak the icon. For example, if the audio icon is the audio version of the word “Compaq,” the user would simply speak the word “Compaq” into the microphone 114. From there, commonly known speech recognition logic (“SRL”), either in the client (logic 116) or in the mnemonic conversion service 104, is used to translate the audio signal into a recognizable alphanumeric phrase. One of ordinary skill in the art is aware of numerous embodiments of speech recognition logic or software. The alphanumeric phrase can then be provided to the mnemonic conversion service if the speech recognition logic is included in the client, or the phrase may already be in the mnemonic conversion service 104 if the speech recognition logic is included therein.

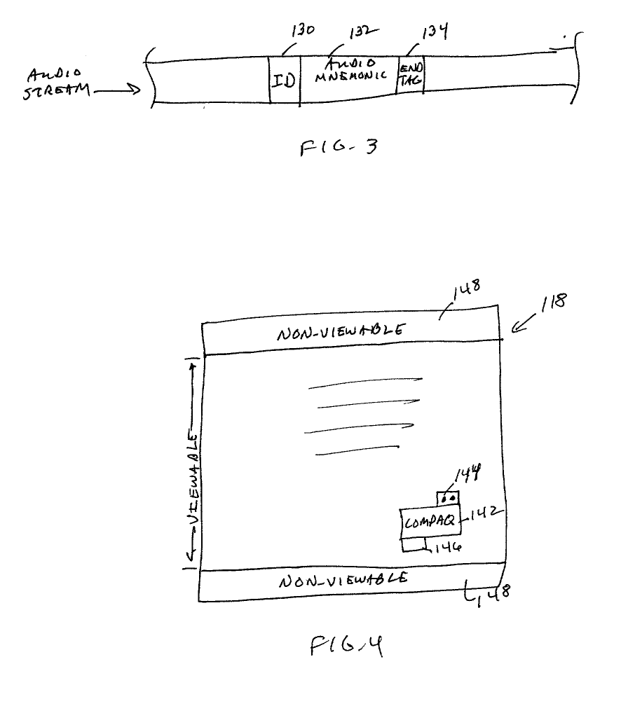

Further still, the audio icon could be embedded in an audio broadcast stream such as an Internet radio station or the audio stream could be part of a video clip. The client system 102 could be programmed to examine the incoming audio stream (which would come from any one of a variety of on-line audio sources). The client 102 examines the audio stream for predefined mnemonic identifiers. As shown in FIG. 3, for example, the audio stream could include a mnemonic 132 preceded by a mnemonic identifier 130 which preferably comprises a standard tone, series of tones or any audio signal generally accepted to be an identifier. The client 102 examines the audio stream for the presence of the mnemonic identifiers 130. When, the client system detects the presence of the mnemonic identifier, the client knows that the audio information that follows the identifier is the mnemonic itself. If desired, the mnemonic could be followed by an end tag 134 tone or series of tones to inform the client that the mnemonic 132 has ended. This permits mnemonics that are embedded in audio streams to be of variable length. Alternatively, all audio mnemonics included in an audio stream could be required to be of a predetermined length so that the client can calculate the end of the audio mnemonic 132 after it detects the identifier tone 130.

If the mnemonic is visual in nature (e.g., a logo), software on the client 102 could examine incoming web pages for such mnemonics. Similar in nature to the technique for identifying audio mnemonics in FIG. 3, visual mnemonics could be tagged with a predetermined visual identifier. Referring to FIG. 4, a web page is shown on a client display 140. A video mnemonic 142 is included somewhere on the display, and the video mnemonic 142, which is free form in general, is identified by pattern recognition software (not shown) on the client identifying a predetermined video mnemonic identifier 144 which could be the same for all video mnemonics. As with the audio mnemonics, the video mnemonics could all be required to be a predetermined size and shape or a end tag identifier 146 can be included to mark the boundary of the video mnemonic 142. Although the identifier 146 and end tag 146 are shown in the upper right and lower left corners of the mnemonic, alternatively they could be in any other location so as to identify the beginning and ending of the mnemonic, such as in the upper left and lower right corners. Instead of the video mnemonics be shown on the viewable part of the display, the video mnemonics could be included in the raster lines 148 that are non-viewable.

Once a mnemonic is detected by a client, the client could permit the user through, for example, a graphical interface to immediately use the mnemonic to access the associated website. Alternatively, the mnemonic can be stored in a separate file or list to permit the user to access the associated website later. Audio mnemonics could be stored as a graphical icon that, when selected, replays the audio mnemonic and then the user could be prompted whether to go to the web site associated with that mnemonic. Alternatively, audio mnemonics could stored temporarily in the client 102 which could be an Internet audio player with no display. While stored in the client, the user could select the mnemonic by playing it back and pressing a button on the device. Video mnemonics could be stored in the list and the user could simply select the mnemonic. The same would be true for text character string mnemonics.

Referring still to FIGS. 1 and 2, after the mnemonic is entered and/or obtained in step 150, the mnemonic is converted to a URL in step 152 by the mnemonic conversion service 104. Preferably, this service is implemented on a server computer which includes a processor 122 and other known components. This is accomplished by comparing the mnemonic received from client 102 to the registered list of mnemonics in the database 120. If no match is found, a predetermined action can be performed, such as performing a “best guess,” a random selection from the list of URLs, or the user is sent a message so indicating. If, on the other hand, a match is found, the URL associated with the matching mnemonic is used to permit the client 102 to access the target web page 108. In accordance with one embodiment, the URL is provided back to the client 102. The client's browser then forwards the URL to the well-known Domain Name Service (“DNS”) 106 which converts (step 154) the URL to the Internet Protocol (“IP”) address associated with the URL. The IP address is then provided back the client and the client then accesses the target web page directly using the web page's IP address (step 156).

Other variations on the visual type of mnemonic are possible as well. For example, a video clip could have various frames containing mnemonics that are recognized by the computer, but are displayed to quickly for the user to recognize them. Software executed by the computer's processor, in conjunction with whatever video player software the computer executes could examine the incoming video stream for these brief visual mnemonics. Such mnemonics could be identified in accordance with any one of a variety of techniques. For example, the mnemonic could have associated with a certain value identifying the mnemonic as a mnemonic. Alternatively, every n number of frames may be preset to be dedicated to mnemonics. Then value of n could be set so that, for example, once per second, a frame is shown containing mnemonics. The computer's software detects these frames and stores the mnemonics to permit the user to access the websites associated with the mnemonic.

Alternatively, a visual mnemonic could be implemented in a video clip by the user simply positioning the cursor or a portion of the screen or “clicking” on a portion of the screen during the video clip. A data file could be provided to the computer along with the video clip. The data file, which is processed by software executing on the computer, preferably includes information that identifies various areas of the screen at certain points in time during the video clip that, when clicked or otherwise selected, causes the mnemonic conversion process described above to occur. The input value to the mnemonic conversion service could be a value indicative of a screen location and time or frame number within the clip. The mnemonic conversion service could convert that information to a URL.

Alternatively, a short sequence of images (from one or more consecutive frames) of the whole video frame along with the clicked pointer co-ordinate (or a portion of the video frame in the proximity of the mouse pointer) would be captured and sent to the mnemonic conversion service. There it could be searched for the presence of registered video icons. The searching process would be simplified in the case where the video stream is identified. Then, only the icons known to be present in that stream would need to be searched for. Icons could be identified by any of their properties including, but not limited to, color, shape, texture or changes on subsequent frames (i.e., blinking). Again, time information could also be used to reduce the extent of the icon search.

The preferred embodiments described above permit users to access web sites without the burden of having to know or obtain the site's URL. The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A method of accessing a website, comprising:
(a) entering a mnemonic on an electronic device, the mnemonic being representative of the web site, but not being a uniform resource location (“URL”) for the website;
(b) converting the mnemonic to a URL; and
(c) using the URL to access the website.

2. The method of claim 1 wherein (a) includes speaking the mnemonic into a microphone.

3. The method of claim 1 wherein the mnemonic comprises an audio signal.

4. The method of claim 3 wherein the mnemonic is included in an audio stream received over the Internet.

5. The method of claim 4 wherein the audio stream includes an audio identifier indicating the presence of the mnemonic.

6. The method of claim 1 wherein the mnemonic comprises a video image.

7. The method of claim 16 wherein the video image is a still image.

8. The method of claim 16 wherein the video image is a moving image.

9. The method of claim 1 wherein the mnemonic comprises an alphanumeric character string.

10. The method of claim 1 wherein (b) includes transmitting the mnemonic to an on-line conversion service which finds a URL associated with the mnemonic.

11. The method of claim 10 wherein the mnemonic is an audio signal and transmitting the mnemonic includes transmitting a digital representation of the audio signal to the on-line service.

12. A method of providing access to a website, comprising:
(a) providing a mnemonic associated with the website to an on-line mnemonic conversion service; and
(b) providing a URL associated with the website to the conversion service;
wherein said mnemonic is representative of the website, but is not the URL.

13. The method of claim 12 further including storing said mnemonic and said URL at said conversion service.

14. A computer system, comprising:
a processor;
an input device coupled to said processor; and
a display device coupled to said processor;
wherein a mnemonic is entered via said input device, the mnemonic being representative of a website, but not being a URL and said computer provides said mnemonic to an on-line conversion service which converts the mnemonic to a URL.

15. The system of claim 14 wherein the input comprises a microphone and the mnemonic is entered by speaking the mnemonic into said microphone.

16. The system of claim 14 wherein the mnemonic comprises an audio signal.

17. The system of claim 16 further including an interface to the Internet and wherein the mnemonic is included in an audio stream received over the interface from the Internet.

18. The system of claim 17 wherein the audio stream includes an audio identifier indicating the presence of the mnemonic.

19. The system of claim 14 wherein the mnemonic comprises a video image.

20. The system of claim 19 wherein the video image is a still image.

21. The system of claim 19 wherein the video image is a moving image.

22. The system of claim 14 wherein the mnemonic comprises an alphanumeric character string.

23. The system of claim 14 further including an interface to the Internet over which the mnemonic is transmitted to an on-line conversion service which finds a URL associated with the mnemonic.

24. The system of claim 23 wherein the mnemonic is an audio signal and a digital representation of the mnemonic is transmitted to the on-line service.

25. A computer system, comprising:
a processor;
an input device coupled to said processor;
a display device coupled to said processor; and
an interface to a network;
wherein a audio mnemonic is received in an audio stream received over said network, the audio mnemonic being representative of a website, but not being a URL and said computer provides said mnemonic to an on-line conversion service which converts the mnemonic to a URL.

26. The system of claim 25 wherein the audio stream also includes a mnemonic identifier to identify the audio mnemonic.

27. The system of claim 26 wherein the audio stream also includes an end tag to identify the end of the audio mnemonic.

28. A server, comprising:
a processor; and
an interface to a network;
wherein said processor receives a mnemonic over said network from an entity, the mnemonic being representative of a website, but not being a URL.

29. The server of claim 28 wherein said processor provides a URL associated with the mnemonic to said entity.
